(19) United States
(12) Patent Application Publication
(10) Pub. No.: US 2022/0088551 A1
(43) Pub. Date: Mar. 24, 2022

(54) DEVICE AND METHOD FOR CREATING AN EMULSION

(71) Applicant: Fluigent, Le Kremlin-Bicêtre (FR)

(72) Inventors: Kejian Wang, Le Kremlin-Bicêtre (FR); Clémence Vergne, Paris (FR); Lionel Matthys, Paris (FR)

(73) Assignee: Fluigent, Le Kremlin-Bicêtre (FR)

(21) Appl. No.: 17/425,668

(22) PCT Filed: Jan. 27, 2020
(86) PCT No.: PCT/EP2020/051949

§ 371 Date: Jul. 23, 2021

(30) Foreign Application Priority Data
Jan. 25, 2019 (FR) FR1900690

(51) Int. Cl. B01F 23/41

(52) U.S. Cl. CPC B01F 23/4105; B01F 23/4145

(57) ABSTRACT

Device for creating an emulsion consisting of a dispersed phase in the form of drops in a continuous phase, the device comprising:
a motion generator (11) in order to put into motion at least one first fluid (3) intended to form the dispersed phase;
a first channel (21) inside which the first fluid (3) put into motion can flow, the first channel (21) extending towards an output orifice (23) through which the first fluid is injected into at least one second fluid (5) intended to form the continuous phase;
a variation system (40) for varying the internal volume (Vi) of the first channel (21) over time.

### TECHNICAL FIELD

The invention relates to a device and method for creating an emulsion composed of a dispersed phase in the form of drops in a continuous phase. This device and this method can be used in particular to create drops ranging from several tenths of a millimeter to a few millimeters in diameter.

### BACKGROUND

An emulsion is a heterogeneous medium composed of two immiscible liquids substances known as phases. A discontinuous phase is dispersed in the other, continuous phase, in the form of drops or droplets. Emulsions are often composed of an aqueous phase and an oily phase. They are used in many fields such as cosmetics, the agri-food industry, pharmacy, etc.

In industry, emulsions are mostly produced in batches: the two liquid substances are mixed and subjected to mechanical constraints. A device which is widely used for this purpose, comprising a helix provided with slots, is sold under the brand name “ultra-turrax”. Emulsions can also be prepared by sonification, i.e. by means of ultrasound, or by passing a mixture from a high-pressure reservoir to a low-pressure reservoir via a multitude of pores. The emulsions which are prepared according to these different techniques are however poly-dispersed: their drops have a wide variety of diameters.

In order to produce mono-dispersed emulsions, i.e., the drops of which have substantially the same diameter, other techniques have been proposed. According to one technique, two immiscible liquid phases are thrust by a syringe pump in order to be sheared in a flow of Couette (Mabille et al., Langmuir 2000, 16, 422-429). According to another technique, oil is injected into a flow of water forming the continuous phase, through the pores of a membrane (Joscelyne et al., Journal of Membrane Science 169 (2000), 107-117). However, the emulsions which are prepared according to these techniques still have a level of poly-dispersity which is too high for certain applications.

In order to reduce further the level of poly-dispersity, techniques using microfluidics or millifluidics have been proposed. In this case, the liquids flow in channels, the dimensions of which are generally a millimeter or less for microfluidics, or a few millimeters at the most for millifluidics. Drops can then be formed according to different geometries, examined in particular in the publication by Baroud et al., Lab on Chip, 2010, 10, 2032-2045. These methods make it possible to obtain mono-dispersed emulsions, but only for certain speeds of flow and certain dimensions of drops. In particular, when the speed of flow or the size of the drops increases, the drops are driven out of the injection orifice of the dispersed phase, and drawn into the continuous phase. When a drop is drawn, a “tail” is formed. However, this tail breaks down into a plurality of secondary drops or satellites smaller than the main drop, which is detrimental to the mono-dispersion sought. This problem of satellite drops is posed in particular when the diameter of the drops is approximately a millimeter. These techniques also require very stable flows in order to obtain the mono-dispersion sought.

There is therefore a need for a new technique making it possible to create emulsions with a low level of poly-dispersity, even for large sizes of drops and high speeds of flow, which for example are compatible with a production which is continuous, and not in batches.

### GENERAL PRESENTATION

The subject of the present invention is a device for creating an emulsion composed of a phase dispersed in the form of drops in a continuous phase, the device comprising:
a motion generator in order to put into motion at least one first fluid which is intended to form the dispersed phase;
a first channel inside which the first fluid put into motion can flow, the first channel extending towards an output orifice via which the first fluid is injected into at least one second fluid which is intended to form the continuous phase;
a variation system in order to make the interior volume of the first channel vary with time; and
an electronic control circuit comprising:
   a control unit to control the motion generator, which is configured to generate a first signal with extrema, referred to as “first extrema”, to make the flow of the first fluid in the first channel vary with time;
   a control unit to control the variation system, which is configured to generate a second signal with extrema, referred to as “second extrema”, to make the interior volume of the first channel vary with time; and
   a coordination system connected to the control units, and configured to associate first and second extrema two by two, with a predetermined temporal offset between two associated extrema.

In particular, a first extremum corresponds to a temporary injection of the first fluid into the second fluid.

In particular, a second extremum corresponds to an increase followed by a decrease of the interior volume of the first channel.

Such a device makes it possible to associate, in particular for successive first extrema, a second extremum with a first extremum, with a predetermined temporal offset between the associated first and second extrema.

For example, for a first signal which has a series of N first extrema (referred to, hereinafter, as the first series, where N is a whole number equal to 2 or more), and a second signal with a series of N second extrema (referred to, hereinafter, as the second series), the coordination system can coordinate, or associate, the first extrema and the second extrema two by two in their order of appearance (thus forming N pairs of associated extrema), by imposing a predetermined temporal offset between the first extremum and the second extremum of each pair of extrema. Thus, for the nth (or n^{th}, n being a whole number between 1 and N) pair of extrema, involving the nth first extremum of the first series and the nth second extremum of the second series, there is a predetermined temporal offset between the first extremum and the second extremum. This predetermined temporal offset is generally the same for the N pairs of extrema concerned.

The coordination system thus makes it possible to associate with an end of injection of the first fluid into the second fluid, an increase of the interior volume of the first channel. This increase gives rise to aspiration of part of the drop of first fluid which is, or has just been, injected into the second fluid. This aspiration makes the tail of the drop fragile, and the drop becomes detached faster than in the absence of aspiration of this type, which also has the effect of reducing the length of the tail. The tail is thus less liable to break up into satellite drops. This makes it possible to prepare emulsions with a distribution of the drop sizes which is better controlled than that obtained by means of the techniques of the prior art. The invention is thus particularly well-suited to the preparation of an emulsion containing drops of the same size, while reducing the level of poly-dispersity of the emulsion. According to another example, the invention can be used to prepare an emulsion, the distribution of the drop sizes of which comprises a plurality of peaks at predetermined sizes.

The dispersed phase can be formed by one or a plurality of first fluids. However, hereinafter, for the sake of concision, reference is made only to one first fluid. Similarly, the continuous phase can be formed by one or a plurality of second fluids, but, hereinafter, reference is made only to one second fluid. The first and second fluids themselves can be mixtures of a plurality of fluids.

The motion generator can have different forms without departing from the context of the invention, provided that it makes it possible to put the first fluid into motion intermittently. In particular, it can be a peristaltic pump, a metering pump, a syringe or a piston pump, a gear pump, a cam pump, a membrane pump, a pulse pressure generator, a pressurized reservoir associated with a valve, etc.

The variation system can also have different forms without departing from the context of the invention, provided that it makes it possible to vary the interior volume of the first channel intermittently, and to obtain the aspiration phenomenon sought. According to one example, it can be a deformation system, which makes it possible to modify the form of the channel, and, in particular, to vary the cross-section of a portion of the channel. According to another example, the channel may comprise a main branch and a lateral branch, and the variation system can vary the interior volume of the lateral branch which is accessible to the first fluid, for example by means of a piston, a compression mechanism or a thermal effect, by varying the position of a membrane, by expanding a bubble, or by any other appropriate means. In certain embodiments, which are preferred for their limited number of components, the variation system and a part of the motion generator, in particular a valve of said system, can be gathered together in a single device, said device having the possibility either of interrupting the flow of fluid in the channel, according to a first operating mode, or of modifying the volume of said channel, according to a second operating mode. This can be carried out for example by means of a progressive valve comprising a volume which is displaced during the operation of the valve.

According to other embodiments, which are preferred for their flexibility, the variation system for varying the volume is distinct from the motion generator.

The control unit of the motion generator and the control unit of the variation system may be configured to generate a first periodic signal and a second periodic signal, the periods of these signals being in particular equal.

In the present application, “extremum” (“extrema” in the plural) designates a local maximum or a local minimum of the signal concerned. An extremum may, in particular, correspond to the top of a peak in a sinusoidal or triangular signal, or to a step in a square or rectangular signal. A variation (increase or decrease) followed by a return (decrease or increase) to or towards the initial state is associated with each extremum.

It will be noted that, depending on the embodiment, a signal may contain main extrema, which are associated with the generation of drops or with the largest values of change of volume of the channel, and secondary extrema, which are associated, for example, with irregularities of the control system or with physical systems, or with any other cause. In such cases, only the main extrema are involved, and only these are subjected to processing by the coordination system. In addition, in the case of periodic signals, the periodic nature of the signal can be limited to a periodic appearance over a period of time of the main extrema, without the signal as a whole being periodic in all its details. In particular, the secondary extrema need not be periodic.

In the particular case of a rectangular signal, no limitation is envisaged with reference to the duration of the extreme amplitude step (i.e. maximum or minimum amplitude) relative to the timescale concerned. However, in certain embodiments, the duration of the step is between 10 ms and 5 s, more particularly between 20 ms and 500 ms. In addition, in the case of series of pulses in the form of periodic signals, the duty cycle (i.e. the ratio between the duration of a pulse and the period of the signal) can be between 0% and 95%, more particularly between 10 and 70%.

The temporal offset imposed by the coordination system between the associated extrema can be determined empirically upon completion of a series of prior tests, or by calculation, taking into account in particular the speed of flow of the first fluid in the first channel, the length of the first channel between the motion generator and the variation system, and between the variation system and the output orifice, the speed of flow of the second fluid, the volume of the drops, the physical and chemical properties of the first and the second fluid (e.g. viscosity, surface tension, etc.), the properties of the variation system (e.g. elasticity of the channel, etc.), the volume of aspiration carried out by the variation system, etc. For given emulsion production conditions, once the temporal offset has been determined empirically or calculated, it is generally maintained fixed during the production, i.e. the predetermined temporal offset is the same for all the pairs of associated extrema.

In certain embodiments, the first channel is a microchannel. “Microchannel” designates a channel which comprises on at least one portion of its length a cross-section with at least one dimension of a millimeter or less, said dimension being measured in a straight line from one edge to an opposite edge of the cross section. A microchannel may have for example a ratio of surface to volume which is substantially greater than 1 mm⁻¹, preferably 4 mm⁻¹, for example 10 mm⁻¹, or even 1 μm⁻¹. In the present invention, the term “microchannel” also includes channels which are commonly known in the literature as a “nanochannel”, “microfluidic channel”, “mesochannel” and “mesofluidic channel”. A microchannel can have a transverse cross-section which is or is not constant. This cross-section may for example be circular, rectangular, square, or it may have the form of a basin. When the cross-section is rectangular, the microchannel may for example have a thickness of between 10 μm and 100 μm, and a width of between 20 μm and 1 mm, in particular a width of between 20 μm and 500 μm. Again by way of example, the microchannel may have a length of between 1 mm and 50 cm, in particular between 1 cm and 10 cm.

In certain embodiments, the variation system pinches or compresses a deformable portion of the first channel, in order to make the interior volume of the first channel vary. In this case, advantageously, at least one portion of the first channel is elastically deformable so as to regain, completely or partly, its initial form by itself or in a stimulated manner when it is no longer pinched or compressed. This solution is simple, economical and robust, which makes it well suited for use in industry.

In certain embodiments, the control units are configured to generate a first periodic signal and a second periodic signal, the periods of these signals being in particular equal. This makes it possible to generate drops with a constant spacing between two consecutive drops, and thus generate an emulsion with a constant concentration of drops.

In certain embodiments, the motion generator comprises: a reservoir in which the first fluid is maintained under pressure, with this reservoir supplying the first channel by means of a supply duct, and a valve which is fitted between the supply duct and the first channel, this valve being controllable by the control unit of the motion generator, such as to allow the first fluid to pass intermittently into the first channel. Said valve may for example be an all-or-nothing valve, this type of valve making it possible to ensure the required function, while having a design which is simple, robust and economical, and thus well-suited for use in industry. An example of a motion generator of this type is described hereinafter and illustrated in the appended figures.

Another example of a motion generator comprises a reservoir, or enclosure, containing the first fluid to be injected into the first channel. A gas circuit passes through the reservoir. This circuit comprises, going from upstream towards downstream in the direction of circulation of the gas, a source of pressure (e.g. a pump or a compressed gas cylinder), an input branch which is connected to the source of pressure, the reservoir, and an output branch. A solenoid valve is placed in the input branch in order to regulate the flow of gas coming from the source of pressure and going into the reservoir. Another valve, known as the leak valve, or a permanent gas exhaust (i.e. a constant leak) is placed in the output branch in order to control the flow of gas leaving the reservoir. Motion generators of this type are described, for example, in patent FR 2855076. By regulating the opening of the valves, it is possible to establish a controlled flow of gas into the reservoir. In particular, the solenoid valve can be connected to the control unit of the motion generator, with this unit controlling the opening of the solenoid valve so as to generate the intermittent motion of the first fluid.

In certain embodiments, for associated first and second extrema, the predetermined temporal offset Dt between these two extrema is between −2 s and +2 s, in particular between −500 ms and +500 ms, in particular between 0 and +500 ms, and more particularly between 0 and +100 ms. In the case of rectangular signals, the predetermined temporal offset is measured between the end of the step which forms the first extremum and the start of the step which forms the second extremum. In a good number of cases, this makes it possible to aspirate at the right time part of the drop of the first fluid which is, or has just been injected into the second fluid. As previously mentioned, this aspiration makes the tail of the drop fragile and the drop becomes detached faster than in the absence of aspiration of this type, which also has the effect of reducing the length of the tail. The tail is thus less liable to break up into satellite drops.

In certain embodiments, the device comprises a second channel inside which the second fluid can flow, and another motion generator in order to put the second fluid into motion continuously in the second channel. The output orifice of the first channel opens into the second channel. In this embodiment, the two fluids are in motion.

This makes it possible to adjust the speeds of flow of the two fluids, in particular in order to obtain a required concentration of drops in the continuous phase. As a variant, the second fluid may be stagnant, and the output orifice of the first channel may be displaced inside the second fluid. According to another variant, the second fluid may be stagnant, and the drops may be displaced therein under the action of an external force, such as, in a non-limiting manner, buoyancy, a confinement gradient, or a dielectrophoretic force. The second channel may be a microchannel.

In certain embodiments, said second channel has a widening of cross-section downstream from the output orifice of the first channel. This geometry of the second channel makes it possible to reduce further the generation of satellite drops.

In certain embodiments, the device may also comprise a detector to detect the size and/or the form of the drops formed by the first fluid in the second fluid.

In certain embodiments, the control units are configured to generate signals, the first and second extrema of which vary according to the size and/or the form of the drops which are formed by the first fluid in the second fluid, and detected by the detector. A configuration of this type makes it possible to ensure additional regularity in the formation of drops over a period of time.

The present invention also relates to a method for creating an emulsion composed of a phase dispersed in the form of drops in a continuous phase, comprising:
putting into motion a first fluid which is intended to form the dispersed phase, so that the first fluid flows inside a first channel extending towards an output orifice via which the first fluid is injected into a second fluid intended to form the continuous phase;
generating a first signal with first extrema, in order to make the flow of the first fluid in the first channel vary with time;
generating a second signal with second extrema, in order to make the interior volume of the first channel vary with time; and
coordinating the first and second signals, so as to associate first and second extrema two by two, with predetermined temporal offset between two associated extrema.

In particular, a first extremum corresponds to a temporary injection of the first fluid into the second fluid.

In particular, a second extremum corresponds to an increase followed by a decrease of the interior volume of the first channel.

A method of this type makes it possible, for a plurality of successive first extrema, to associate a second extremum with each first extremum, with predetermined temporal offset between two associated extrema.

The advantages of this method are similar to those of the device previously described.

In certain embodiments, the first and second signals are periodic, the periods of the signals being in particular equal.

In certain embodiments, the first fluid is aqueous and the second fluid is oily, or conversely. Thus, a dispersed aqueous phase in a continuous oily phase, or a dispersed oily phase in a continuous aqueous phase, is obtained. The oily phase may, for example, be a fluid based on silicon oil or mineral oil. The oil may be partly or completely fluorinated, vegetable, or it can be a mixture of these oils. In other embodiments, the first fluid and the second fluid are two aqueous phases rendered immiscible by solutes contained in these phases.

The first and/or the second fluid may for example contain or constitute a biologically active product, a cosmetic product, an edible product, a lubricant product, a sanitary or phytosanitary product, a coating product or a surface treatment product. In this case, the emulsion which is created from the two fluids contains, or itself constitutes, a biologically active product, a cosmetic product (e.g. skin care, hair care or make up), an edible product, or a lubricant product, or a combination of these products.

The biologically active product can be selected, for example, from amongst vitamins, hormones, proteins, antiseptics, drugs, polysaccharides, peptides, polypeptides and oligopeptides, proteoglycans, nucleic acids, lipids, etc., and any combination of these products.

The cosmetic product can for example be a product for the skin (hands, face, feet, etc.) or the lips, a foundation, a preparation for baths and showers, a hair care product, a shaving product, or a sun product, etc.

The edible product, which can be consumed by a human being or an animal may for example be a food oil (olive oil, sesame oil, sunflower oil, etc.), a juice or a purée of vegetables or fruits, a food additive or dietary supplement, etc.

In certain embodiments, the drops of the dispersed phase are spherical or spheroidal (i.e. substantially spherical) with a mean diameter (i.e. a mean diameter in number) greater than 0.1 mm, in particular greater than 0.5 mm. The drops may also have a different form (i.e. non-spherical) with a volume greater than that of a sphere having a diameter of 0.1 mm, in particular with a volume greater than that of a sphere having a diameter of 0.5 mm. In contrast with the known methods, even for drops of this size, the method proposed makes it possible to obtain a low level of poly-dispersity.

In the present invention, “mono-dispersed emulsion” means an emulsion with a population of drops which has a distribution of sizes, i.e. diameters, which is substantially regular. On the other hand, if the distribution of the drop sizes is not regular, the emulsion is said to be poly-dispersed. A mono-dispersed emulsion has a low level of poly-dispersity.

In particular, if the drops produced are spherical, it is possible to use the coefficient of variation Cv which reflects the distribution of the diameters of the drops in order to evaluate the mono-dispersity. The diameter Di of a drop is for example measured by analysis of a photograph of a batch constituted by N drops, by an image processing software. Typically, according to this method, the diameter Di is measured in pixels, then added in μm, according to the size of the container containing the emulsion. Preferably, the value of N is selected to be 30 or more, such that this analysis reflects statistically significantly the distribution of the diameters of the drops of the emulsion. Once the diameters Di have been measured, there is calculation of the mean diameter (i.e. the mean diameter in number) D by calculating the arithmetical mean of the diameters Di.

$$D = \frac{1}{N} {\sum }_{i = 1}^{N} Di \qquad [ Math 1 ]$$

On the basis of the diameters Di and the mean diameter D, it is possible to calculate the standard deviation a of the diameters of the drops.

$$σ = \sqrt{\frac{{\sum }_{i = 1}^{N} {( Di - D )}^{2}}{N}} \qquad [ Math 2 ]$$

The standard deviation a reflects the distribution of the diameters Di of the drops around the mean diameter D. 95% of the population of drops is found in the interval of diameters [D−2σ; D+2σ] and 68% of the population is found in the interval [D−σ; D+σ].

In order to characterize the level of poly-dispersity of the emulsion, it is possible to calculate the coefficient of variation Cv which reflects the distribution of the diameters of the drops according to the mean diameter thereof.

$$Cv = \frac{σ}{D} \qquad [ Math 3 ]$$

It is considered that an emulsion is mono-dispersed, i.e. that it has a low level of poly-dispersity, when Cv is lower than 50%, preferably lower than 20%, and even better lower than 10%.

In certain embodiments, the drops of the dispersed phase are spherical or spheroidal (i.e. substantially spherical) with a mean diameter smaller than 30 mm, and in particular smaller than 10 mm. The drops can also have a different form (i.e. non-spherical) with a volume smaller than that of a sphere having a diameter of 30 mm, in particular with a volume smaller than that of a sphere having a diameter of 10 mm.

Thus, in certain embodiments, the drops of the dispersed phase have a mean diameter of between 1 μm and 30 mm, in particular between 10 μm and 10 mm, in particular between 0.1 mm and 5 mm, and more particularly between 0.5 mm and 3 mm. In addition, if the drops produced are non-spherical, this same method of evaluation of the mono-dispersity can be applied to the distribution of the masses in the place of the distribution of the diameters.

The invention also relates to an emulsion composed of a dispersed phase in the form of drops in a continuous phase, obtained by means of the method previously defined.

The aforementioned characteristics and advantages, as well as others, will become apparent from reading the following detailed description of embodiments of the device and of the method proposed. This detailed description refers to the appended drawings.

### BRIEF DESCRIPTION OF THE DRAWINGS

The appended drawings are schematic, and are not necessarily to scale; their objective is above all to illustrate the principles of the invention. In these drawings, from one figure (fig) to another, elements (or parts of elements) which are identical are indicated by the same reference signs.

FIG. 1 This figure represents an example of a device according to one embodiment.

FIG. 2 This figure is a detailed view of FIG. 1 representing an example of a variation system according to one embodiment.

FIG. 3 This figure is a series of graphs (A) to (D) representing respectively: (A) an example of the control signal sent to the motion generator by its control unit; (B) an example of the control signal sent to the variation system by its control unit; (C) the temporal variation of the flow of first fluid in the first channel; and (D) the temporal variation of the interior volume of the first channel.

FIG. 4 This figure is a photograph of an emulsion created by means of the device in FIG. 1, without the variation system being activated.

FIG. 5 This figure is a photograph of an emulsion created by means of the device in FIG. 1 with the variation system activated and controlled as illustrated in FIG. 4.

FIG. 6 This figure is a diagram illustrating the formation of drops at the output of the first channel in the device of FIG. 1 according to an embodiment.

FIG. 7 This figure is a diagram representing an example of the geometry of the second channel.

FIG. 8 This figure is a photograph of an example of an emulsion created by means of a device according to the invention.

FIG. 9 This figure is a photograph of another example of an emulsion created by means of a device according to the invention.

### DETAILED DESCRIPTION OF EXAMPLES

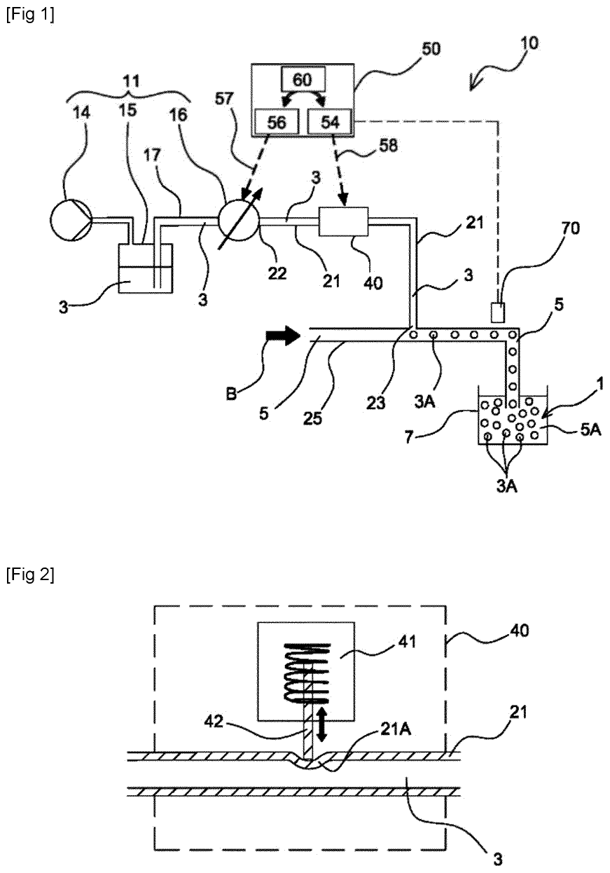

Examples of the device and of the method proposed are described in detail hereinafter with reference to the appended drawings. These examples illustrate the characteristics and the advantages of the invention. It should however be remembered that the invention is not limited to these examples. FIG. 1 represents an example of a device 10 for creating an emulsion 1 composed of a phase dispersed in the form of drops 3A in a continuous phase 5A. This emulsion 1 is collected, for example, in a container 7.

The device 10 comprises:
a motion generator 11 in order to put into motion at least one first fluid 3 which is intended to form the dispersed phase;
a first channel 21 inside which the first fluid 3 put into motion can flow, with the first channel 21 extending from the motion generator 11 to an output orifice 23 via which the first fluid 3 is injected into at least one second fluid 5 which is intended to form the continuous phase 5A;
a variation system 40 for making the interior volume of the first channel 21 vary with time; and
an electronic control circuit 50 which makes it possible to command, or control, the motion generator 11 and the variation system 40.

In this example, the motion generator 11 comprises a reservoir 15 of first fluid 3.

This reservoir 15 is pressurized by means of a source of pressure 14, for example a microfluidic pressure controller (e.g. the controller sold under the name “Flow EZ” by the company Fluigent, France), and is associated with a solenoid valve 16, for example an all-or-nothing solenoid valve (e.g. the solenoid valve which is sold under the name “VX243AZ3AAXB” by the company SMC, Japan). The reservoir 15 supplies the first channel 21 by means of a supply duct 17, with the solenoid valve 16 being situated at the connection between the supply duct 17 and the first channel 21. The controlled opening and closure of the solenoid valve 16, which takes place alternately, makes it possible to make the first fluid 3 advance intermittently in the first channel 21. The first channel 21 extends from the solenoid valve 16 (which forms part of the motion generator 11) as far as the output orifice 23. The first channel 21 opens into a second channel 25 in which the second fluid 5 circulates. The injection of the second fluid 5 into the second channel 25 is symbolized by the arrow B in FIG. 1. The second channel 25 opens into the container 7. In the example, the first and the second channels 21, 25 are connected in the form of a “T”. These channels 21, 25 may be microchannels.

The variation system 40 is situated downstream from the solenoid valve 16, in the direction of circulation of the first fluid 3. An example of a variation system 40 is illustrated in FIG. 2. This system 40 compresses a deformable portion 21A of the first channel 21, in order to vary the interior volume of the first channel. This portion 21A of the first channel is elastically deformable, and can thus regain its initial form by itself, completely or partly, when it is no longer compressed. The system 40 may for example be an actuator 41 with an electromagnet comprising a rod 42 which is mobile in translation, as illustrated by the double arrow in FIG. 2. A system of this type is sold under the name “Small linear solenoid for intensive use” by the company Mecalectro. In another embodiment (not shown) the solenoid valve 16 and the variation system 40 are combined in a single system.

The controlled displacement of the rod 42 makes it possible to compress the portion 21A in a controlled manner. When the portion 21A of the first channel 21 is compressed by the rod 42, the interior volume of the first channel 21 decreases. Conversely, when it is no longer compressed, the portion 21A regains its initial form, and the interior volume of the first channel 21 increases, thus creating the required aspiration effect.

The electronic control circuit 50 comprises a control unit 56 which is configured to generate a first signal 57 with first extrema which control the generator 11 so as to generate variations of the flow of first fluid 3 in the first channel 3A, with each first extremum corresponding to a temporary injection of the first fluid 3 into the second fluid 5, via the output orifice 23 of the first channel 21. Hereinafter, reference is made to the primary pulse in order to designate the increase and decrease of the signal around a first extremum. In the example, the control unit 56 controls the opening and closure of the solenoid valve 16.

The electronic control circuit 50 also comprises a control unit 54 which is configured to generate a second signal 58 with second extrema which control the variation system, so as to generate variations of the interior volume of the first channel 21, with each second extremum corresponding to an increase followed by a decrease of the interior volume of the first channel 21. Hereinafter, reference is made to the secondary pulse in order to designate the increase and decrease of the signal around a second extremum. In the example, the control unit 54 controls the actuator 41, and thus the compression of the portion 21A of the first channel 21 by the rod 42.

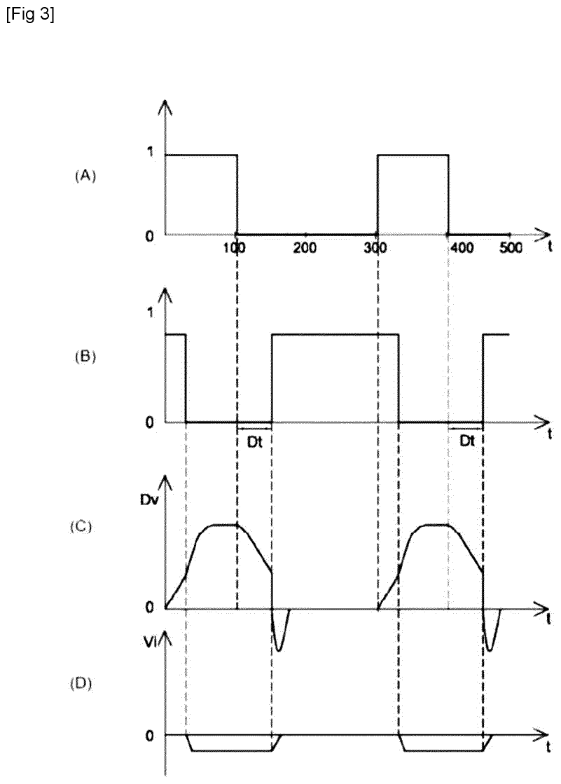

The electronic control circuit 50 also comprises a coordination system 60 which is connected to the control units 54, 56, and is configured to associate a secondary pulse with a primary pulse, with predetermined temporal offset between the two associated pulses. This aspect is illustrated in FIGS. 3 to 6. In the example, a second extremum is associated with each first extremum.

The graphs A to D in FIG. 3 represent respectively:

A: an example of a first control signal sent to the solenoid valve 16 by the control unit 56, this first signal being schematized by the arrow 57 in FIG. 1;
B: an example of a second control signal sent to the variation system 40 by the control unit 54, this second signal being schematized by the arrow 58 in FIG. 1;
C: an example of variation with time of the flow of first fluid 3 in the first channel 21;
D: an example of variation with time of the interior volume of the first channel 21.

The graph A of FIG. 3 represents, on the y-axis, the first control signal 57 for the solenoid valve 16, and, on the x-axis, the time expressed in milliseconds. The control signal 57 which is sent by the control unit 56 is a square signal which varies between a first and a second value, in this case between 0 and 1. When the signal is equal to 1, it commands the opening of the solenoid valve 16, and consequently the putting into motion of the first fluid 3 in the first channel 3A (cf. graph C), and the start of the injection of the first fluid 3 into the second fluid 5. When the signal 57 is equal to 0, it commands the closure of the solenoid valve 16, and consequently the progressive stoppage of the first fluid 3 in the first channel 3A, and the end of the injection of the first fluid 3 into the second fluid 5.

The example of a first control signal 57 of the graph A in FIG. 3 is composed of a succession of first extrema according to the invention, with each first extremum corresponding to a limited time-lapse during which the signal 57 commands the putting into motion of the first fluid (i.e. during which the value of the signal 57 is maximum and, in this case, equal to 1).

The graph B in FIG. 3 represents on the y-axis the second control signal 58 for the variation system 40, and, on the x-axis, the time expressed in milliseconds. The control signal 58 which is sent by the control unit 54 is a square signal which varies between a first and a second value, in this case between 0 and 1. When the signal 58 is equal to 0, it commands the descent of the rod 42 (cf. FIG. 2), and consequently the compression of the first channel 21. When the signal is equal to 1, it commands the raising of the rod 42, and consequently the release or relaxing of the first channel 21, which regains its initial form by means of elasticity.

The example of a second control signal 58 of the graph B in FIG. 3 is composed of a succession of second extrema according to the invention, with each second extremum corresponding to a limited time-lapse during which the first channel 21 is no longer compressed (i.e. during which the value of the signal 58 is maximum and, in this case, equal to 1).

In the example of FIG. 3, each second extremum starts after the end of the associated first extremum. There is therefore a temporal offset Dt between the start of the secondary pulse and the end of the associated primary pulse. In the example, this offset Dt is less than 100 milliseconds (ms) and approximately equal to 50 ms. The variation of the first control signal 57 (graph A) results in the variation of the flow of first fluid 3 in the first channel 21 represented in graph C. Graph C represents on the y-axis the flow Dv of the first fluid 3 in the first channel 21, expressed in arbitrary flow units, and, on the x-axis, the time t expressed in ms. The variation of the flow Dv is a consequence of the pulses (graph A) of the first signal 57. The flow Dv increases when the first signal 57 is 1, and it decreases when the first signal 57 goes to 0.

The variation of the second control signal 58 (graph B) results in the variation of the interior volume of the first channel 21 represented in graph D. Graph D represents, on the y-axis, the interior volume Vi of the first channel 21 expressed as an arbitrary volume unit, and, on the x-axis, the time t expressed in milliseconds. The variation of the interior volume Vi is a consequence of the secondary extrema: during the compression of the first channel 21, the volume Vi decreases and, during the relaxation, the volume Vi increases and returns to its initial value. It will be noted that the negative flow associated with the start of a second pulse (graph C) is derived from the aspiration phenomenon previously described.

The increase of the interior volume Vi of the first channel 21 gives rise to aspiration of the first fluid 3 at the output opening 23 of the first channel 21. As a result of the coordination created between this aspiration and the movement of the first fluid 3, the aspiration at the output opening 23 intervenes rather towards the end of the injection of the drop 3A, which makes the tail of the drop 3A fragile, and the drop becomes detached sooner, with a shorter tail.

In order to better understand the phenomenon in question, a diagram representing the formation of a drop 3A of first fluid 3 at the output orifice 23 of the first channel 21 is given in FIG. 6. As illustrated, when a drop becomes detached from the output orifice 23, a tail 9 forms at the rear of the drop, which will tend to break up into a plurality of secondary drops or satellites 19 which are smaller than the main drop. FIG. 6 illustrates a “conventional” formation of drops 3A, without aspiration.

Contrary to what is illustrated in FIG. 6, the invention creates an aspiration effect at the output orifice 23, which makes the tail 9 of the drop 3A fragile. As a consequence, the drop 3A becomes detached sooner than in the absence of aspiration of this type, with a shorter tail 9. The tail is thus less liable to break up into satellite drops 19.

It will be noted that, in certain embodiments, in addition to the aspiration effect, the output orifice 23 of the channel 21 can be made of a particular material, or it can be subjected to surface treatments in order to have desired physical and chemical properties (e.g. hydrophobic or hydrophilic, etc.), according to the fluids 3, 5 used, in order to reduce the number of satellite drops 19 during the detachment of these drops 9. Similarly, the channel 25 of the second liquid 5 can also be made of a particular material, or it can be subjected to surface treatments in order to have desired chemical and physical properties (e.g. hydrophobic or hydrophilic) in order to reduce the risk of drops 3A getting caught on the interior walls of the channel.

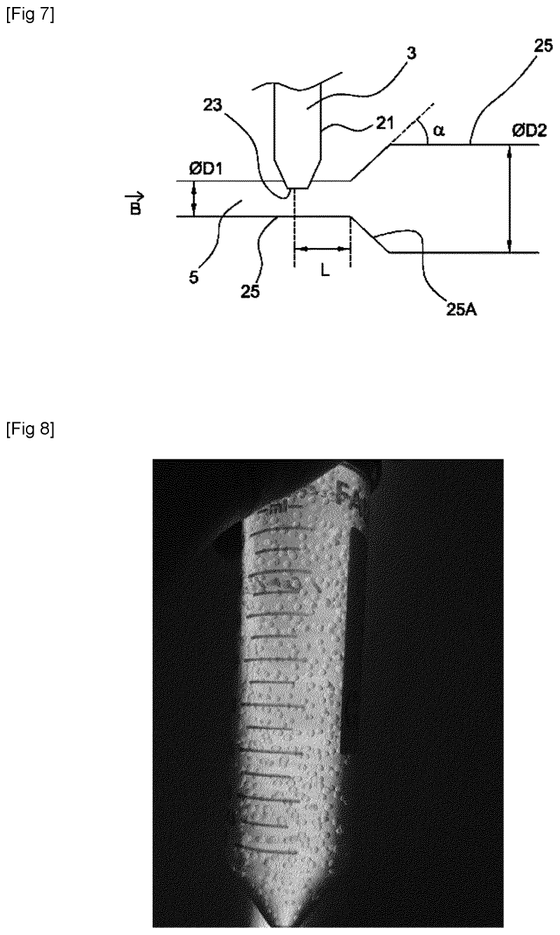

In addition, in certain embodiments, the second channel 25 has a widening of cross-section 25A downstream from the output orifice 23 of the first channel 21, as represented in FIG. 7. A widening 25 of this type makes it possible to reduce the generation of satellite drops 19.

For example, for a second channel 25 with a circular cross-section, the ratio D2/D1 between the inner diameter D2 of the channel after widening 25A and the inner diameter D1 of the channel before widening 25A is between 1 and 20. In addition, the distance L between the center of the output orifice 23 and the start of the widening 25A is less than 50 mm. As a variant or as a complement, the distance L can be 10 times smaller than, in particular 5 times smaller than, and more particularly twice as small as the size of the drops.

The angle of widening α of the second channel 25 may be between 5° and 90°. According to a specific example, D1=3 mm, D2=8 mm, L=3 mm and α=59°.

The parameters D2, D1, D2/D1, L and α can be adjusted, inter alia, according to the size of the drops 3A, the frequency of generation of the drops, the physical and chemical properties, as well as the flows of the fluids 3, 5 implemented.

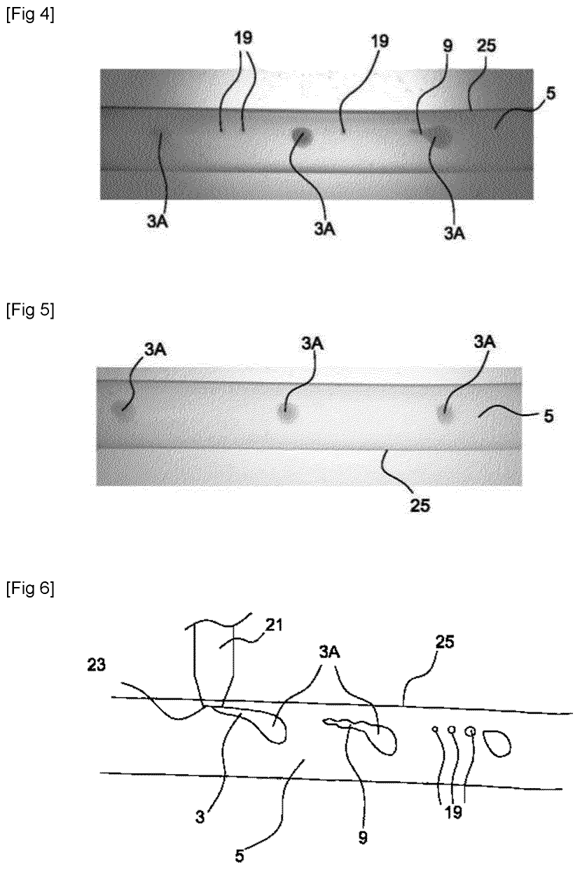

FIG. 4 is a photograph of the drops circulating in the device 10 in FIG. 1, without the variation system 40 being activated, i.e. without the portion 21A of channel being compressed, and thus without an aspiration phenomenon. In contrast, FIG. 5 is a photograph of an emulsion created by means of the device in FIG. 1 with the variation system 40 activated and controlled as illustrated in the graph B of FIG. 3. In both cases (FIGS. 4 and 5), the motion generator 11 has been activated and controlled as illustrated in the graph A of FIG. 3.

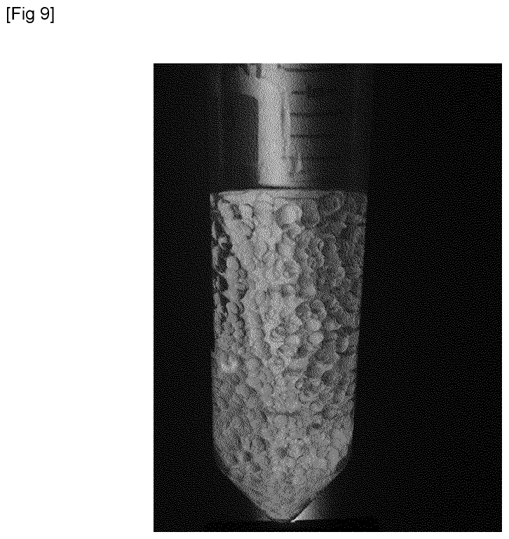

As can be seen in the photo in FIG. 4, without a variation system 40 activated, and thus without aspiration, the drops 3A have a tail 9 which breaks up into a plurality of satellite drops 19 smaller than the main drop. In contrast, as illustrated in FIG. 5, with the variation system 40 activated, the phenomena of drop tails or satellite drops disappear. Optionally, the device 10 in FIG. 1 can comprise a feedback loop which is formed in particular by a detector 70 connected to the electronic control circuit 50. The detector 70 makes it possible to detect the size and/or the form of the drops 3A formed by the first fluid 3 in the second fluid 5. Information concerning the size and/or the form of the drops 3A is sent by the detector 70 to the control units 54, 56. According to this information, the control units 54, 56 adapt the duration and/or the frequency of the first and second extrema, or/and the offset Dt between the associated extrema, or/and also the volume of variation in the variation system 40. FIGS. 8 and 9 are photographs of emulsions created by means of a device according to the invention, of the same type as the one in FIG. 1. The emulsion in FIG. 8 is such that the drops which constitute it have a mean diameter of approximately 1 mm, and the volume concentration of these drops is approximately 0.6%. In FIG. 9, the drops of the emulsion have a mean diameter of approximately 2.9 mm, and the volume concentration of these drops is approximately 35%.

The embodiments or examples which are described in the present invention are given by way of non-limiting illustration, and in the light of this invention persons skilled in the art can easily modify these embodiments or examples or envisage others, while remaining within the scope of the invention. In particular, persons skilled in the art could easily envisage variants comprising only some of the features of the embodiments or examples previously described, if these features alone are sufficient to provide one of the advantages of the invention. In addition, the different features of these embodiments or examples may be used alone or combined with one another. When they are combined, these features may be combined as described above or differently, since the invention is not limited to the specific combinations described herein. In particular, unless otherwise stated, a characteristic described in relation with one embodiment or example can be applied in an analogous manner to another embodiment or example.

1. A device for creating an emulsion composed of a phase dispersed in the form of drops in a continuous phase, the device comprising:
a motion generator in order to put into motion at least one first fluid which is intended to form a dispersed phase;
a first channel inside which the first fluid put into motion can flow, the first channel extending towards an output orifice via which the first fluid is injected into at least one second fluid which is intended to form the continuous phase;
a variation system in order to make an interior volume of the first channel vary with time; and
an electronic control circuit comprising:
a first control unit to control the motion generator, which is configured to generate a first signal with first extrema, to make a flow of the first fluid in the first channel vary with time;
a second control unit to control the variation system, which is configured to generate a second signal with second extrema, to make the interior volume of the first channel vary with time; and
a coordination system connected to the control units, and configured to associate first and second extrema two by two, with a predetermined temporal offset between two associated extrema.

2. The device according to claim 1, wherein a first extremum corresponds to a temporary injection of the first fluid into the second fluid.

3. The device according to claim 1, wherein a second extremum corresponds to an increase followed by a decrease of the interior volume of the first channel.

4. The device according to claim 1, wherein the first channel is a microchannel.

5. The device according to claim 1, wherein the variation system is configured to pinch or compress a deformable portion of the first channel, in order to make the interior volume of the first channel vary.

6. The device according to claim 1, wherein the first and second control units are configured respectively such that the first signal generated is a signal wherein the main extrema appear periodically, and such that the second signal generated is a signal in which the main extrema appear periodically, the periods of these signals being equal.

7. The device according to claim 1, wherein the first and second control units are configured to generate first and second signals which vary according to the size and/or the form of the drops which are formed by the first fluid in the second fluid.

8. The device according to claim 1, further comprising a detector to detect the size and/or the form of the drops formed by the first fluid in the second fluid.

9. The device according to claim 1, wherein the motion generator comprises:
a reservoir in which the first fluid is maintained under pressure, with the reservoir supplying the first channel by means of a supply duct; and
a valve which is fitted between the supply duct and the first channel, said valve being controllable by the control unit of the motion generator, so as to allow the first fluid to pass intermittently into the first channel.

10. The device according to claim 1, wherein for associated first and second extrema, the predetermined temporal offset between these two extrema is between −2 s and +2 s.

11. The device according to claim 1, comprising:
a second channel inside which the second fluid can flow, and
another motion generator in order to put the second fluid into motion continuously in the second channel, wherein the output orifice of the first channel opens into the second channel.

12. The device according to claim 11, wherein the second channel has a widening of cross-section downstream from the output orifice of the first channel.

13. A method for creating an emulsion composed of a dispersed phase in the form of drops in a continuous phase, comprising:
putting into motion a first fluid which is intended to form the dispersed phase, so that the first fluid flows inside a first channel extending towards an output orifice via which the first fluid is injected into a second fluid intended to form the continuous phase;
generating a first signal with first extrema, in order to make a flow of the first fluid in the first channel vary with time;
generating a second signal with second extrema, in order to make an interior volume of the first channel vary with time; and
coordinating the first and second signals, so as to associate first and second extrema two by two, with predetermined temporal offset between two associated extrema.

14. The method according to claim 13, wherein a first extremum corresponds to a temporary injection of the first fluid into the second fluid.

15. The method according to claim 13, wherein a second extremum corresponds to an increase followed by a decrease of the interior volume of the first channel.

16. The method according to claim 13, wherein the first signal generated is a signal wherein the main extrema appear periodically, and the second signal generated is a signal wherein the main extrema appear periodically, the periods of these signals being equal.

17. The method according to claim 13, wherein the first fluid is aqueous and the second fluid is oily, or conversely.

18. The method according to claim 13, wherein the drops of the dispersed phase are spherical or spheroidal, with a mean diameter greater than 0.1 mm, or they have a different form, with a volume greater than that of a sphere having a diameter of 0.1 mm.

19. The method according to claim 13, wherein the drops of the dispersed phase are spherical or spheroidal, with a diameter smaller than 30 mm, or they have a different form, with a volume smaller than that of a sphere having a diameter of 30 mm.

20. An emulsion comprising a phase dispersed in the form of drops in a continuous phase, obtained by the method according to claim 13.
